(19) United States
(12) Patent Application Publication
(10) Pub. No.: US 2004/0239859 A1
(43) Pub. Date: Dec. 2, 2004

(54) In-plane switching liquid crystal display with symmetric electrodes

(76) Inventors: Cheuh-Ju Chen, MIao-Li (TW); Jia-Pang Pang, MIao-Li (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/858,772

(22) Filed: Jun. 1, 2004

(30) Foreign Application Priority Data
May 30, 2003 (TW) 92114851

(51) Int. Cl. G02F 1/1343

(52) U.S. Cl. 349/141

(57) ABSTRACT

An IPS LCD includes a first substrate (21), a second substrate (22), and a liquid crystal layer (23) between the first and second substrates. The first substrate includes a first polarizer (210), a first transparent plate (211) and a color filter layer (212) stacked one on the other from top to bottom in that order. The second substrate includes a second polarizer (220), a second transparent plate (221), an insulating layer (222), a passivation layer (224) and an alignment layer (225) stacked one on the other from bottom to top in that order. A data line (226) is disposed on the second transparent plate, and is covered by the insulating layer. A pixel electrode (223) and a common electrode (227) are separately disposed on the passivation layer, and are covered by the alignment layer. The symmetry of the pixel and common electrodes enables the IPS LCD to eliminate the image sticking phenomenon.

### BACKGROUND OF THE INVENTION

1. Field of the Invention

the present invention relates to active matrix liquid crystal displays, and particularly to in-plane switching liquid crystal displays.

2. The Prior Art

Unlike CRTs (cathode ray tubes) and OELDs (organic electroluminescent displays), liquid crystal displays do not emit light themselves. Liquid crystal displays work on the principle of blocking light rather than emitting it. Thus liquid crystal displays consume much less power than CRTs and OELDs. In a typical liquid crystal display, electrodes distributed on two parallel transparent glass substrates apply an electric field to control the twisting of liquid crystal molecules interposed between the two transparent glass substrates. In an ideal model, the liquid crystal molecules in the electric field are arranged perpendicular to the glass substrates. However, it is difficult to obtain the ideal model due to interactions of the liquid crystal molecules and the effects of gravity.

FIGS. 4 and 5 show one sub-pixel area of a conventional in-plane switching liquid crystal display (IPS LCD). The liquid crystal display 1 includes a first substrate 11, a second substrate 12, and a liquid crystal layer 13 interposed between the first substrate 11 and the second substrate 12.

The first substrate 11 includes a first polarizer 110, a first transparent plate 111, a color filter layer 112, and a first alignment layer 113 stacked one on the other from top to bottom in that order.

The second substrate 12 includes a second polarizer 120, a second transparent plate 121, an insulating layer 122, a passivation layer 124, a second alignment layer 125, a common electrode 126, a pixel electrode 123, and a data line 127. The second polarizer 120, the second transparent plate 121, the insulating layer 122, the passivation layer 124 and the second alignment layer 125 are stacked one on the other from bottom to top in that order. The common electrode 126 is disposed on the second transparent plate 121, and is covered by the insulating layer 122. The pixel electrode 123 and the common electrode 126 are separately disposed on the insulating layer 122, and are both covered by the passivation layer 124.

The liquid crystal layer 13 includes liquid crystal molecules 130, which are made of a nematic type liquid crystal material. The nematic type liquid crystal material contains ions that move under the influence of an electric field.

The first alignment layer 113 and the second alignment layer 125 have same alignment directions, and the liquid crystal molecules 130 between the first substrate 11 and the second substrate 12 are controlled to align along the alignment directions. The polarizing axis of the first polarizer 110 is essentially perpendicular to that of the second polarzier 120, and the alignment directions of the first alignment layer 113 and the second alignment layer 125 are parallel to the polarizing axis of the second polarizer 120.

When no electric field is applied across the liquid crystal layer 13, as shown in FIG. 4, the liquid crystal molecules 130 are aligned along the alignment directions of the first alignment layer 113 and the second alignment 125. Thus, linearly polarized light beams that are produced by the second polarizer 120 have a same direction of polarization as the polarizing axis of the second polarizer 120, and can directly cross through the liquid crystal layer 13. The linearly polarized light beams are blocked by the first polarizer 110 because the polarization direction of the linearly polarized light beams is perpendicular to the polarizing axis of the first polarizer 10. In this way, a black display is obtained.

When an electric field 14 essentially parallel to the first and the second substrates 11, 12 is applied across the liquid crystal layer 13, as shown in FIG. 5, the liquid crystal molecules 130 are aligned along the direction of the electric field 14, which is essentially perpendicular to the alignment directions of the first alignment layer 113 and the second alignment 125. Due to the birefringent characteristics of the liquid crystal molecules 130, the polarization direction of linearly polarized light beams produced by the second polarizer 120 is changed to a same direction as the polarizing axis of the first polarizer 110 when the linearly polarzied light beams cross the liquid crystal layer 13. Thus, the linearly polarzied light beams can cross the first polarizer 110. In this way, a bright display is obtained.

Because the liquid crystal display 1 is an in-plane switching liquid crystal display (IPS LCD), it has much better viewing angle characteristics than more classical types of liquid crystal displays such as twisted nematic and super twisted nematic liquid crystal displays.

However, the common electrode 126 and pixel electrode 123 are disposed on the second transparent plate 121 and the insulating layer 122, respectively. Therefore the distance between the common electrode 126 and the liquid crystal layer 13 is different from the distance between the pixel electrode 123 and the liquid crystal layer 13. In other words, the common electrode 126 and the pixel electrode 123 are asymmetrically distributed in the liquid crystal display 1. When the electric field 14 is applied across the liquid crystal layer 13, due to the difference in distances, the common electrode 126 has an ability to capture ions that is different from that of the pixel electrode 123. Thus the ions contained in the liquid crystal layer 13 gradually cluster on the common electrode 15 or the pixel electrode 16, which is liable to lead to the so-called image sticking phenomenon after a period of time.

An improved IPS LCD which overcomes the above-mentioned disadvantages is desired.

### SUMMARY OF THE INVENTION

An object of the present invention is to provide an IPS LCD which reduces or even eliminates any image sticking phenomenon.

In order to achieve the object set forth, an IPS LCD in accordance with the present invention comprises a first substrate, a second substrate, and a liquid crystal layer interposed between the first and second substrates. The first substrate comprises a first polarizer, a first transparent plate and a color filter layer stacked one on the other from top to bottom in that order. The second substrate comprises a second polarizer, a second transparent plate, an insulating layer, a passivation layer and an alignment layer stacked one on the other from bottom to top in that order. A data line is disposed on the second transparent plate, and is covered by the insulating layer. A pixel electrode and a common electrode are separately disposed on the passivation layer, and are both covered by the alignment layer. When an electric field is applied across the liquid crystal layer, the common electrode has the same ability to capture ions as the pixel electrode because they are symmetrically disposed in the IPS LCD. Thus, the ions contained in the liquid crystal layer do not become clustered on the common electrode or the pixel electrode, thereby substantially reducing or even eliminating the image sticking phenomenon.

Other objects, advantages and novel features of the invention will become more apparent from the following detailed description when taken in conjunction with the accompanying drawings, in which:

### BRIEF DESCRIPTION OF THE DRAWINGS

FIG. 1 is a schematic, cross-sectional view of one sub-pixel area of an IPS LCD according to a first embodiment of the present invention;

FIG. 2 is a schematic, cross-sectional view of one sub-pixel area of an IPS LCD according to a second embodiment of the present invention;

FIG. 3 is a schematic, cross-sectional view of one sub-pixel area of an IPS LCD according to a third embodiment of the present invention;

FIG. 4 is a schematic, cross-sectional view of one sub-pixel area of a conventional IPS LCD, shown without an electric field applied thereat; and

FIG. 5 is similar to FIG. 4, but shown with an electric field applied thereat.

### DESCRIPTION OF THE PREFERRED EMBODIMENTS

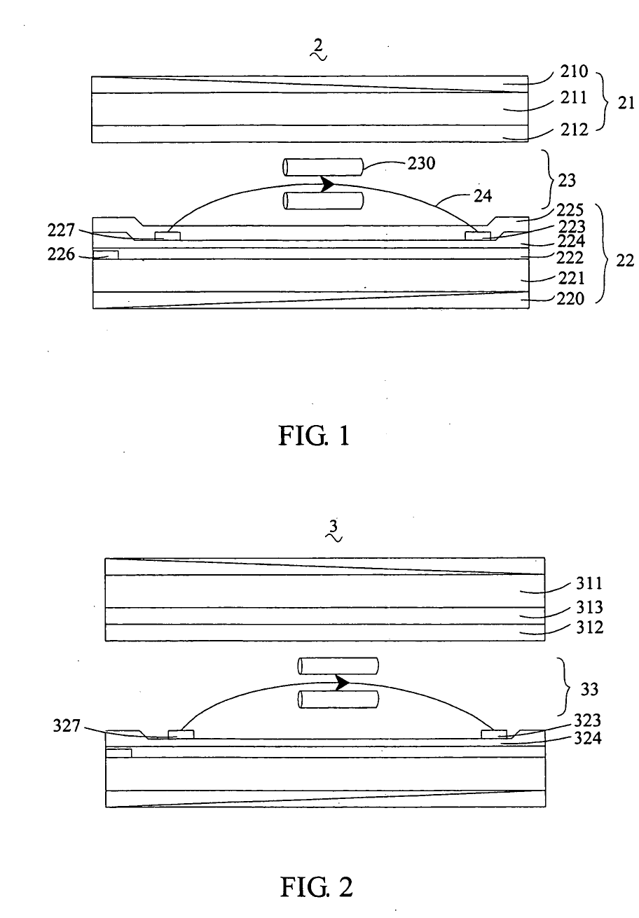

FIG. 1 is a schematic view of one sub-pixel area of an IPS LCD 2 according to the first embodiment of the present invention. The IPS LCD 2 includes a first substrate 21, a second substrate 22, and a liquid crystal layer 23 interposed between the first substrate 21 and the second substrate 22.

The first substrate 21 includes a first polarizer 210, a first transparent plate 211 and a color filter layer 212 stacked one on the other from top to bottom in that order.

The second substrate 22 includes a second polarizer 220, a second transparent plate 221, an insulating layer 222, a passivation layer 224, an alignment layer 225, a common electrode 227, a pixel electrode 223, and a data line 226. The second polarizer 220, the second transparent plate 221, the insulating layer 222, the passivation layer 224, and the second alignment layer 225 are stacked one on the other from bottom to top in that order. The data line 226 is disposed on the second transparent plate 221, and is covered by the insulating layer 222. The pixel electrode 223 and the common electrode 227 are separately disposed on the passivation layer 224, and are both covered by the alignment layer 225. The pixel electrode 223 and the common electrode 227 can be made of indium tin oxide, or a metal such as gold (Au), silver (Ag), copper (Cu), etc. In the illustrated embodiment, the material of the pixel electrode 223 and the common electrode 227 is indium tin oxide.

The liquid crystal layer 23 is made of a nematic type liquid crystal material, and includes liquid crystal molecules 230. The nematic type liquid crystal material contains ions that move under the influence of an electric field.

The polarizing axis of the first polarizer 210 is essentially perpendicular to that of the second polarzier 220, and the alignment layer 225 has alignment directions which are parallel to the polarizing axis of the second polarizer 220. The liquid crystal molecules 230 between the first substrate 21 and the second substrate 22 are controlled to align along the alignment directions.

When an electric field 24 is applied across the liquid crystal layer 23, the common electrode 227 has the same ability to capture ions as the pixel electrode 223 because they are symmetrically disposed in the IPS LCD 2. Thus, the ions contained in the liquid crystal layer 23 do not become clustered on the common electrode 227 or the pixel electrode 223, thereby substantially reducing or even eliminating any image sticking phenomenon.

FIG. 2 is a schematic view of one sub-pixel area of an IPS LCD 3 according to the second embodiment of the present invention. Unlike the IPS LCD 2 of the first embodiment, in the IPS LCD 3, a color filter layer 313 and an alignment layer 312 are stacked under a first transparent plate 311 from top to bottom in that order. The alignment layer 312 is adjacent to a liquid crystal layer 33, and is provided as a substitute for the alignment layer 225 of the IPS LCD 2. A common electrode 327 and a pixel electrode 323 are symmetrically disposed on a passivation layer 324, and are adjacent to the liquid crystal layer 33. Thus, the common electrode 327 has the same ability to capture ions as the pixel electrode 323, and the IPS LCD 3 can eliminate any image sticking phenomenon.

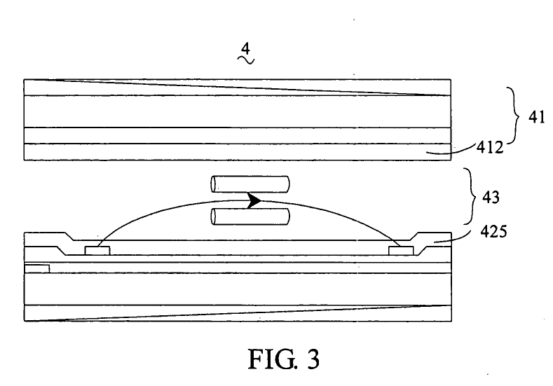

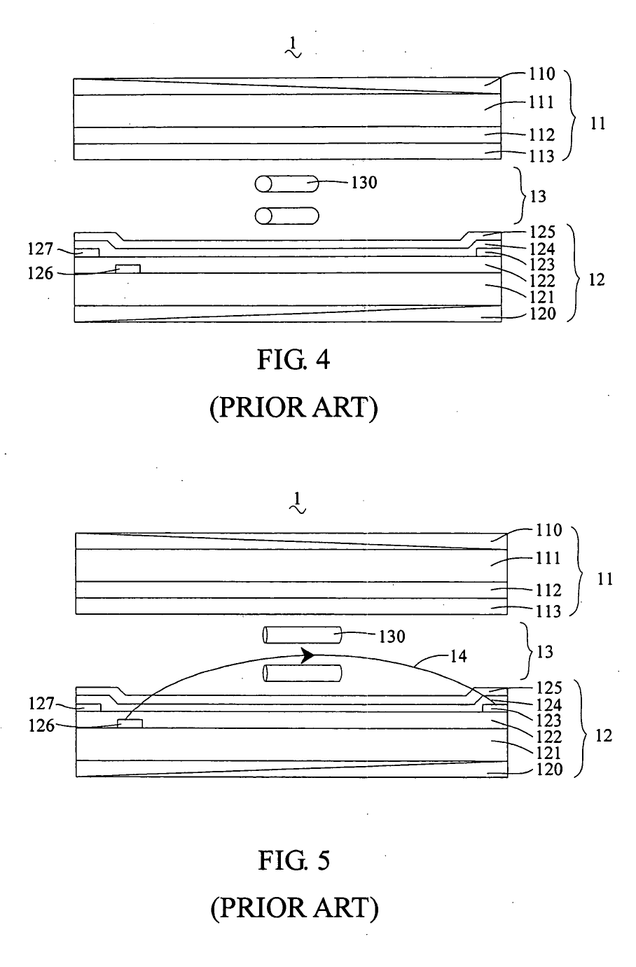

FIG. 3 is a schematic view of one sub-pixel area of an IPS LCD 4 according to the third embodiment of the present invention. Unlike the IPS LCD 2 of the first embodiment, in the IPS LCD 4, a first substrate 41 further includes an alignment layer 412. The alignment layer 412 has the same alignment directions as an alignment layer 425. A liquid crystal layer 43 is interposed between the alignment layers 412, 425. When an electric field (not labeled) is applied across the liquid crystal layer 43, a common electrode (not labeled) has the same ability to capture ions as a pixel electrode (not labeled) because the common and pixel electrodes are symmetrically disposed in the IPS LCD 4. Thus the IPS LCD 4 can eliminate any image sticking phenomenon.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. An In-Plane Switching Liquid Crystal Display (IPS LCD), comprising:
a first substrate comprising a first polarizer and a first transparent plate stacked one on the other from top to bottom in that order;
a second substrate comprising a second polarizer, a second transparent plate, an insulating layer, a passivation layer and an alignment layer stacked one on the other from bottom to top in that order, a data line disposed on the second transparent plate and covered by the insulating layer, and a pixel electrode and a common electrode separately disposed on the passivation layer and covered by the alignment layer; and
a liquid crystal layer interposed between the first and the second substrates.

2. The IPS LCD of claim 1, wherein the first substrate further comprises a color filter layer, and the first polarizer, the first transparent plate and the color filter layer are stacked one on the other from top to bottom in that order.

3. The IPS LCD of claim 1, wherein the liquid crystal layer is made of a nematic type liquid crystal material.

4. The IPS LCD of claim 1, wherein the common electrode and the pixel electrode are made of indium tin oxide.

5. The IPS LCD of claim 1, wherein the common electrode and the pixel electrode are made of gold, silver, or copper.

6. An In-Plane Switching Liquid Crystal Display (IPS LCD), comprising:
a first substrate comprising a first polarizer, a first transparent plate and a first alignment layer stacked one on the other from top to bottom in that order;
a second substrate comprising a second polarizer, a second transparent plate, an insulating layer, and a passivation layer stacked one on the other from bottom to top in that order, a data line disposed on the second transparent plate and covered by the insulating layer, and a pixel electrode and a common electrode separately disposed on the passivation layer; and
a liquid crystal layer interposed between the first and the second substrates.

7. The IPS LCD of claim 6, wherein the first substrate further comprises a color filter layer, and the first polarizer, the first transparent plate, the color filter layer and the first alignment layer are stacked one on the other from top to bottom in that order.

8. The IPS LCD of claim 6, wherein the liquid crystal layer is made of a nemaic type liquid crystal material.

9. The IPS LCD of claim 6, comprising a second alignment layer attached to the passivation layer and covering the pixel electrode and common electrode.

10. The IPS LCD of claim 6, wherein the common electrode and the pixel electrode are made of indium tin oxide.

11. The IPS LCD of claim 6, wherein the common electrode and the pixel electrode are made of gold, silver, or copper.

12. An In-Plane Switching Liquid Crystal Display (IPS LCD), comprising:
a first substrate comprising a first polarizer, a first transparent plate and a first alignment layer stacked one on the other from top to bottom in that order;
a second substrate comprising a second polarizer, a second transparent plate, an insulating layer, and a passivation layer stacked one on the other from bottom to top in that order, a data line disposed on the second transparent plate and covered by the insulating layer, and a pixel electrode and a common electrode separately disposed on a lower level of the layer; and a liquid crystal layer interposed between the first and the second substrates.
